(19) United States
(12) Patent Application Publication
(10) Pub. No.: US 2017/0140668 A1
(43) Pub. Date: May 18, 2017

(54) TACTILE WRITING INSTRUMENT

(71) Applicant: INVENTIVIO GMBH, NUERNBERG (DE)

(72) Inventor: ALEXANDER HARS, NUERNBERG (DE)

(21) Appl. No.: 15/419,507

(22) Filed: Jan. 30, 2017

Related U.S. Application Data
(63) Continuation of application No. PCT/EP2015/067191, filed on Jul. 27, 2015.

(30) Foreign Application Priority Data
Jul. 30, 2014 (DE) 10 2014 011 326.4

(51) Int. Cl. G09B 21/02; G09B 21/00

(52) U.S. Cl. CPC G09B 21/02; G09B 21/003

(57) ABSTRACT

A writing instrument displays a touch point pattern that can be detected in a tactile manner. The instrument has a number of position openings arranged matrix-like in an opening grid in a position plane of a guide device of a lower plate, in which tactile elements are removably inserted. The instrument has in a display plane, an upper plate that is spaced apart vertically from the position plane and has a number of contact openings, each of which is aligned with a corresponding position opening of the lower plate. A write head assembly is guided in a movement direction that is translational relative to the guiding device and has a number of writing heads corresponding to the number of rows, or to a fraction thereof, which convey tactile elements from the lower plate into the upper plate in accordance with the point pattern to be displayed.

### CROSS-REFERENCE TO RELATED APPLICATION

This is a continuation application, under 35 U.S.C. §120, of copending international application No. PCT/EP2015/067191, filed Jul. 27, 2015, which designated the United States; this application also claims the priority, under 35 U.S.C. §119, of German patent application No. DE 10 2014 011 326.4, filed Jul. 30, 2014; the prior applications are herewith incorporated by reference in their entirety.

### BACKGROUND OF THE INVENTION

### Field of the Invention

The invention relates to a writing instrument for displaying a dot pattern which can be perceived in a tactile manner, in particular as Braille script and/or as a graphic.

Such a writing instrument, which is used as an auxiliary device for visually impaired or blind persons, contains a display panel with openings for receiving elements or objects which can be perceived in a tactile manner and which can be moved into the corresponding openings of the display panel in accordance with the desired dot pattern which is generally intended to be displayed as Braille script.

Published, non-prosecuted German patent application DE 10 2006 002 568 A1 discloses a display device which is for displaying display elements (image elements, graphics, drawing elements, characters, symbols) in a manner perceptible in a tactile manner and which converts information output by a computer into Braille script. To this end, on a touch surface individual display pins are controlled by actuation motors in accordance with the output of the computer.

From Japanese patent application JP H04180083 A, it is known to use as an element which can be detected in a tactile manner (touch element) a metal ball which can be moved by a controllable solenoid from a position plane into a display plane and at that location into an opening. In order to keep the ball in the corresponding position, a metal plate is guided below the corresponding opening.

The disadvantage with known devices is in particular the high level of complexity with regard to the drive mechanisms for placing and retaining the tactile pins or balls at the or in the correct position in the display plane (touch surface or display panel). Furthermore, in particular with the use of solenoids only relatively large display surfaces with only a relatively small number of touch elements can be provided. As a result of the dimensions of the solenoids which can be minimized only to a limited extent and the magnetic interactions thereof with relatively large magnetic operating faces, they additionally have to be positioned with correspondingly large spacings with respect to each other in order to prevent undesirable simultaneous lifting of a plurality of balls.

### SUMMARY OF THE INVENTION

An object of the invention is to provide a particularly suitable writing instrument for displaying a dot pattern which can be perceived in a tactile manner, in particular as Braille script and/or as a graphic. In particular, a dot pattern which can be perceived in a tactile manner with the largest possible number of touch dots is also intended to be able to be produced on a relatively small display surface.

This object is achieved according to the invention with the features of the main claim. Advantageous embodiments and developments are set out in the dependent claims.

To this end, the writing instrument has for displaying a dot pattern which can be detected in a tactile manner a guiding device having a lower plate in a lower position plane and an upper plate in a display plane which is vertically spaced apart from the position plane and between these planes a partition plate and suitably above the upper plate a writing head arrangement having a number of writing heads, preferably in the form of controllable solenoids. The solenoids and the partition plate can be moved in a translational manner relative to the guiding device and consequently relative to the upper plate, which constitutes a display surface.

The upper plate and the lower plate have a number of openings which are arranged in the manner of a matrix in lines and columns in an opening grid. This is identical for both plates so that the openings (touch openings) of the upper plate are in alignment with those (position openings) of the lower plate, that is to say, are arranged vertically directly one above the other. In the position openings of the lower plate there are tactile elements which are also referred to below as touch elements, preferably in the form of metal balls. During correct use of the writing instrument, these are transported by the writing head arrangement which is suitably constructed as a solenoid from the lower plate into the upper plate. The touch elements are then located therein in the selected touch openings and protrude at the upper side of the upper plate out of the touch openings at least slightly so that they can be perceived by being touched by the fingers of an operator.

In order to prevent the transport power of the writing head arrangement from being constantly maintained, that is to say, in the preferred embodiment thereof, to prevent the permanent supply thereof with electrical power with solenoids, while the writing head arrangement is moved forward by controlled transport of the touch elements into the openings of the upper plate, at the same time or in a temporally offset manner the openings which have been charged with touch elements are covered below the upper plate by the partition plate which is guided in the movement direction behind the writing head arrangement so that the touch elements cannot fall back into the lower plate.

The partition plate which is also guided in a translational manner contains a first plate region which is permeable to the tactile elements and a second plate region which adjoins the first plate region in the movement or advance direction and which is non-permeable to the touch elements. The first plate region or portion preferably has a number of recesses which corresponds to the number of lines of the opening grid of the touch and/or position openings. The number of recesses may also correspond to the number of writing heads or a fraction thereof.

During the movement of the partition plate, which is preferably synchronized with the movement of the writing head arrangement, the recesses of the partition plate overlap with the openings of the lower and upper plates so that a selective transport channel is formed from a corresponding opening of the lower plate via the corresponding recess of the partition plate to the corresponding opening of the upper plate. The non-permeable plate region of the partition plate adjacent in the movement direction then closes column by column the openings which are provided along the respective line of the upper plate which is also referred to below as a display panel so that the touch elements which are located therein remain in the display panel even when the writing head arrangement is deactivated.

The number of writing heads of the writing head arrangement which is guided relative to the guiding device in the movement direction and which according to the dot pattern which is intended to be displayed conveys the corresponding touch elements from the lower plate into the upper plate corresponds in a first variant to the number of lines of the opening grid of the upper plate (display panel). Alternatively, the number of writing heads may also amount to only a fraction of the number of lines. For example, if the opening grid of the display panel has 384 touch dots in 16 lines and 24 columns, for example, four or eight writing heads may thus be provided and move over the corresponding four or two groups of lines in each case with four or eight lines one after the other in order to provide the corresponding openings of the upper plate with the tactile elements.

In order to produce a dot pattern with a particularly high number of touch dots, for example, in order to produce a graphic, in particular also in the dot grid of 2.5 mm which is conventional for Braille script, in the writing head arrangement at least some of the writing heads are arranged one behind the other in the movement direction and offset with respect to each other in lines. It is thereby possible to use writing heads and in particular solenoids whose dimensions or diameters are greater than the size of the openings of the upper and lower plates. Each writing head is in this instance suitably associated with one of the lines and consequently the openings of the upper plate which are arranged therein one behind the other in the movement direction.

Each line of the opening grid of the upper and lower plates is associated with a recess in the partition plate. Advantageously, a recess in the permeable plate region of the partition plate is associated with each of the writing heads, respectively. The recesses of the partition plate consequently practically screen the transport channel between the corresponding openings of the lower and upper plates which are in alignment with each other laterally, that is to say, in the horizontal partition plate plane. A mutual disruption of the writing heads is thereby prevented in a particularly reliable manner, in particular when they are constructed as solenoids which are preferably arranged in an offset manner.

With appropriate synchronization of the movements of the writing head arrangement and the partition plate using a corresponding drive or movement control, the writing heads are always located during a writing operation which is brought about by the controlled transport of the touch elements above the recess in the partition plate which is associated therewith in each case.

According to a preferred embodiment, the writing head arrangement can also be moved in the opposite direction to the translational movement direction and consequently in a bidirectional manner. In particular in this embodiment, it is particularly advantageous for the partition plate to have at both sides of the first plate region which is permeable to the touch elements a second plate region which is non-permeable to the touch elements. The display surface or panel can consequently be written and/or overwritten in both translational movement directions.

Another embodiment of the partition plate provides for an opening window in the first plate region which is permeable to the touch elements. The opening window extends—when viewed in the transverse direction relative to the movement direction—over at least one line, but suitably over a plurality or even all of the lines, of the opening grid or a fraction thereof. Suitably, the recesses are then provided in the movement direction both upstream and downstream of the opening window. The opening window enables selective and time-saving deletion of the display panel by the touch elements (tactile elements) whose openings have been passed over by the opening window during the movement of the partition plate simultaneously falling back from the upper plate into the lower plate. The recesses of the partition plate which follow during the movement enable the upper plate to be charged again—and consequently enable the display panel or surface to be written on again—with touch elements from the lower plate.

In the bi-directional configuration of the writing instrument, whose partition plate in this embodiment has the additional opening window in the first plate region, one of the two adjacent recess regions serves to move the touch elements from the lower plate into the upper plate in a movement direction, while the other of these two recess regions serves to move the touch elements from the lower plate into the upper plate in the other movement direction.

According to an advantageous development of the writing instrument, the second plate region of the partition plate which is non-permeable to the touch elements can be released from the first plate region which is permeable to the touch elements. In the embodiment with a writing head arrangement which can be displaced in a bidirectional manner, the first plate region which is permeable to the touch elements is adjoined at both sides by a plate region which is non-permeable to the touch elements. These plate regions which are non-permeable to the touch elements suitably have the same dimensions as the upper display panel (upper plate). This embodiment of the partition plate which can be disassembled enables a separation of the upper plate which has been provided with the touch elements in accordance with the desired touch dot patterns, together with the plate region (plate portion) which is impermeable to the touch elements from the guiding device of the writing instrument in order to consequently separately store a display panel which has been correspondingly written with a touch dot pattern which can be detected in a tactile manner, that is to say, can be perceived by touch, or to guide it separately from the writing instrument.

According to a variant, the partition plate is constructed as a resilient partition strip. In an embodiment as a closed partition strip having at least one recess region or the two recess regions which are adjacent to the opening window, this partition strip is advantageously removed from the writing instrument together with the upper plate and the lower plate in order to separately store the display panel which has been accordingly charged correctly.

The tactile elements are preferably spherical, in particular having a ball diameter of (1.5±0.5) mm. The writing heads are advantageously controllable solenoids. In particular in the embodiment of the tactile elements (touch elements) as balls, the clear width of the openings of the upper plate is smaller than the ball diameter. This may in particular be from 1.0 mm to 2.0 mm and preferably 1.6 mm. In order to prevent the touch elements from falling out, a film or similar covering may additionally or alternatively be provided on the upper plate.

With a display surface of the display panel formed by the upper plate of the size DIN A4, with a grid size of 2.5 mm, a total of 9996 balls with a ball diameter of 1.6 mm are provided in a corresponding number of position openings of the lower plate. The thickness of the display panel is then approximately 5 mm so that the display panel can not only be used in a stationary manner, but also a plurality of display panels can instead be carried, for example, in a bag.

Other features which are considered as characteristic for the invention are set forth in the appended claims.

Although the invention is illustrated and described herein as embodied in a tactile writing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a writing instrument for displaying a touch dot pattern of a writing head arrangement, which pattern can be detected in a tactile manner, and having an upper plate, a lower plate and a partition plate between the upper and lower plates, according to the invention;

FIG. 2 is an exploded, perspective view of the writing instrument according to FIG. 1;

FIG. 3 is an illustration showing the partition plate with a closed plate region at both sides of a recess region, respectively;

FIG. 4 is an exploded, perspective view of a variant of the partition plate with recess regions which are arranged at both sides of an opening window and a removable plate region without recesses;

FIG. 5 is an exploded, perspective view of an embodiment of the partition plate as a closed partition strip and removable component together with the upper plate and the lower plate;

FIG. 6 is a schematic view of a recess grid of the partition plate with closed recesses and correspondingly arranged writing heads and an opening grid with a large number of openings which are arranged in the manner of a matrix, for example, in six lines of a display surface;

FIG. 7 is a schematic illustration of another recess grid of the partition plate again with closed recesses overlapping an opening grid of the lower and upper plates, also by way of example with six lines according to FIG. 6;

FIG. 8 is a schematic view of another recess grid of the partition plate with partially open recesses overlapping an open opening grid of the lower and upper plates, again by way of example with six lines; and

FIGS. 9A to 9E are schematic sectioned illustrations for explaining an operating method of the writing instrument in sequential operating steps in a movement direction.

### DETAILED DESCRIPTION OF THE INVENTION

Mutually corresponding components are given the same reference numerals in all the figures.

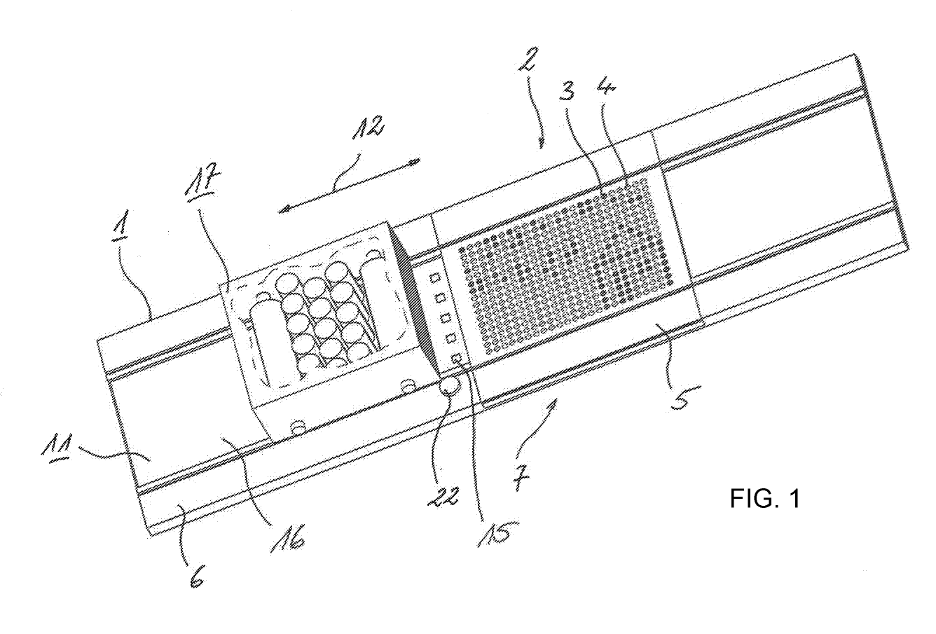

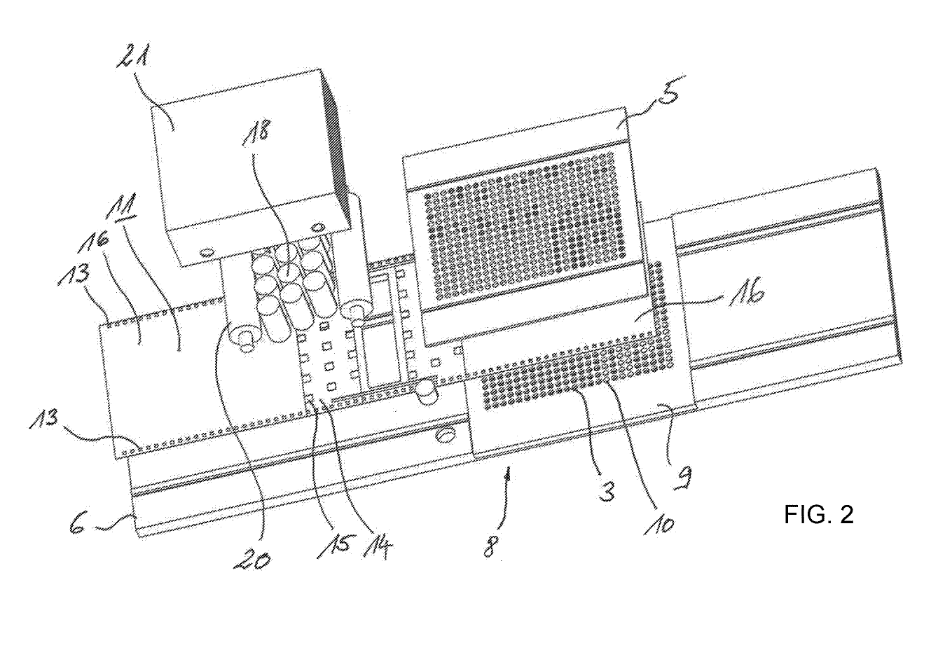

Referring now to the figures of the drawings in detail and first, particularly to FIGS. 1 and 2 thereof, there is shown a writing instrument 1 for displaying a dot pattern which can be detected in a tactile manner on a display surface 2 on which touch elements 3, preferably balls, are arranged as tactile elements (raised units which can be touched). The display surface 2 is formed by touch openings 4 which are arranged in a matrix-like manner in an opening grid in lines and columns, in this instance in the form of circular holes in an upper plate 5. The upper plate 5 is located with respect to a guiding device 6 of the writing instrument 1 in a display plane 7 in which the display surface 2 is located. Each touch opening 4 of the upper plate 5 corresponds to a touch dot which can assume one of two possible states, either by the touch element 3 which can be touched protruding through the opening 4 or the opening 4 being empty and the associated object 3 being located in a position plane 8 which is arranged vertically below the display plane 7. There is in the position plane 8 a lower plate 9 with position openings 10 which are arranged in the same opening grid, in particular in the form of holes or blind holes in which touch elements 3 are again located so as to be able to be removed.

As can be seen comparatively clearly in FIG. 2, a partition plate 11 is arranged between the lower plate 9 and the upper plate 5. This can be moved in a translational manner in a movement direction 12 with respect to the upper plate 5 which is arranged in a fixed manner in the guiding device 6 and the lower plate 9 which is also fixed and to this end is guided in the guiding device 6 in a correspondingly longitudinally displaceable manner. For the translational movement of the partition plate 11, there may be provided a manual or else an electromotive drive which cooperates in a manner not illustrated in greater detail with a perforation 13 at the longitudinal sides of the partition plate 11.

The partition plate 11 has a recess region which is formed by a first plate region or portion 14 and which is permeable to the catch elements 3 and which has a number of recesses 15. It is adjoined in the movement direction 12 by a second plate region or portion 16, which is non-permeable to the touch elements 3, that is to say, completely closed. In the embodiment, both sides of the first plate region (recess region) are adjoined by a second plate region 16 which is non-permeable to the touch elements 3.

There is located above the display plane 7 and consequently above the upper plate 5 a writing head arrangement 17 having a number of writing heads 18 which are arranged in a specific grid. These are constructed in the embodiment as controllable solenoids. The writing heads 18 are arranged in the movement direction 12 in rows one behind the other and in the transverse direction 19 offset thereto. With this arrangement of the writing heads 18, a total of sixteen writing heads 18 can be arranged in only three rows, of which one writing head 18 passes over one of the total of sixteen lines of the display surface 2 in the embodiment or the hole grid of the upper plate 5 in the movement direction 12. To this end, the writing head arrangement 17 is also driven in the movement direction 12.

When viewed in the movement direction 12, there is arranged at each of the two sides of the writing head arrangement 17 a respective rotatable return roller 20, which rollers support pressing-out of the touch elements 3 from the associated touch openings 4 of the upper plate 5. A covering cap 21 covers the writing head arrangement 17 and the return rollers 20. A position sensor 22 which is arranged in the transverse direction 19 laterally beside the partition plate 11 and the writing head arrangement 17 in the guiding device 6 detects—relative to the fixed upper plate 5—the current position of the partition plate 11 and/or the writing head arrangement 17.

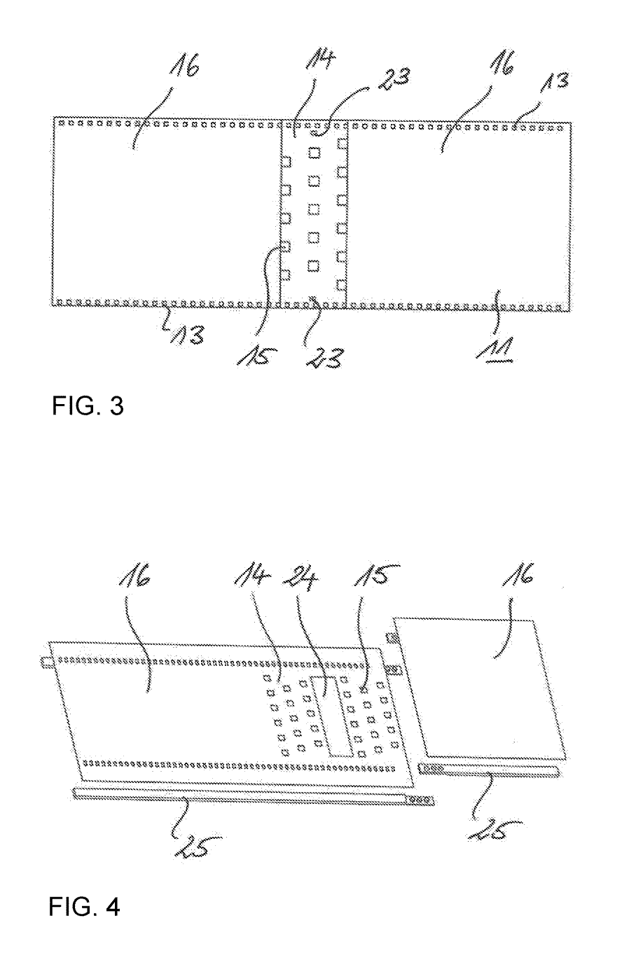

FIG. 3 shows the partition plate 11 with the central first plate region 14 thereof with the recesses 15 which are constructed as a through-opening. It can be seen that they are arranged in the same grid as the writing heads 18. At both sides of this first plate portion 14 which is permeable to the touch elements 3 there are located the two second plate portions 16 which are completely closed and consequently non-permeable to the touch elements 3. In the first plate region 14, there are located in the embodiment in a diametrically opposed manner two recesses 23 in which corresponding carrier pins of the writing head arrangement 17 engage in a manner not illustrated in greater detail. As a result of this mechanical coupling between the writing head arrangement 17 and the partition plate 11, each movement of the partition plate 11 is transmitted to the writing head arrangement 17. If the partition plate 11 is moved manually over the display surface 2, the sensor 22 detects the position of the partition plate 11 and consequently also of the writing head arrangement 17. A non-illustrated control unit establishes the intended position for the touch elements 3 which are located below the writing head arrangement 17 in the upper plate 5 or in the lower plate 9.

Should a touch element 3 be moved into the upper position, the corresponding writing head 18 is controlled and activated. In the embodiment, the corresponding solenoid is supplied with electrical power. Otherwise, the remaining writing head 18 remains deactivated and the corresponding touch element 3 remains in the corresponding opening 10 of the lower plate 9 or falls from the corresponding touch opening 4 of the upper plate 5 into the lower plate 9 and from there back into the corresponding position opening 10. If the writing head arrangement 17 and the partition plate 21 are moved further in the movement direction 12, the second plate portion 16 which is non-permeable to the touch elements 3 prevents the partition elements 3 which have previously been raised by the writing head arrangement 17 and transported into the corresponding touch opening 4 of the upper plate 5 from falling back. In this manner, step by step, each desired touch dot is placed until the writing head arrangement 17 has completely passed over the upper plate 5 and consequently the display surface 2.

In the embodiment of the partition plate according to FIG. 4, an opening window 24 is introduced into the first permeable plate region 14 thereof. This covers all the lines of the opening grid of the upper plate 5 and may extend over several columns. Via this opening window 24, it is consequently possible, when overwriting the display surface 2, for a plurality of touch elements 3 to fall back simultaneously from the upper plate 5 into the lower plate 9.

At both sides adjacent to the opening window 24, there is in each case a recess region with recesses 15 which are arranged in a corresponding recess grid. If the partition plate 11 and with it suitably in a synchronous manner the writing head arrangement 17 move in the movement direction 12, for example, to the right, the writing heads 18 are positioned over the left recess region. If the writing heads 18 move in the movement direction 12 to the left, they are positioned above the right recess region. The writing heads 18 are thereby always located in the movement direction 12 downstream of the opening window 24. The return of the touch elements 3 may be further improved by the return rollers 20 applying a restoring force to the touch elements 3.

Via the carrier openings 23 which are constructed in a manner not illustrated in greater detail in the embodiment of the partition plate 11 according to FIG. 4 as longitudinal slots which extend in the movement direction 12, during a movement of the partition plate 11 in the movement direction 12, or in the opposite direction thereto, the writing head arrangement 17 is also carried in a synchronous manner and in this instance preferably pulled by the partition plate 11 as a result of the coupling thereof to the writing head arrangement 17 so that only the partition plate 11 has to be driven. Alternatively, the writing head arrangement 17 and the partition plate 11 can also be moved separately from each other, for example, in an electromotive manner. In this instance, two sensors 22 then detect the position of the writing head arrangement 17, on the one hand, and the partition plate 11, on the other hand. Using the sensor data, a control unit which is not illustrated in greater detail causes the position of the writing head arrangement 17 and the partition plate 11 to be continuously adapted to each other so that the writing heads 18 are always located over the corresponding recess 14 of the partition plate 11.

As can be seen in FIG. 4, the or each closed second plate region 16 which is impermeable to the touch elements 3 can be separated from the plate region 14 of the partition plate 11 having the recesses 14. To this end, the plate regions 14, 16 are releasably secured to each other in the initial state by means of retention struts 25 which are retained by hole/pin connections. The dimension (surface-area) of the non-permeable plate region 15 is in this instance adapted to the dimension of the display surface 2 of the upper plate 5 and covers practically the entire hole grid of the touch openings 4.

As a result of this configuration, the display surface 2 can be removed from the guiding device 6 for separate storage or for carrying and consequently separated from the writing device 1. A display panel which is formed thereby contains as components a carrier and the upper plate 5 which is provided in the desired and previously produced touch dot pattern with the corresponding touch elements 3 and the non-permeable plate region 16 of the partition plate 11. The lower plate 9 may also be associated with the display panel which can consequently be separated. The corresponding components of the display panel in the form of at least the upper plate 5 and the non-permeable plate region 16 of the carrier plate 11 and where applicable the lower plate 9 may, for example, be joined to each other by means of engagement or screwing. The touch elements 3 are prevented from falling out in a downward direction by the non-permeable plate region 16 and in an upward direction by the fact that the touch openings 4 of the upper plate 5 have an at least slightly larger diameter—that is to say a smaller clear width—than that or those of the touch elements 3.

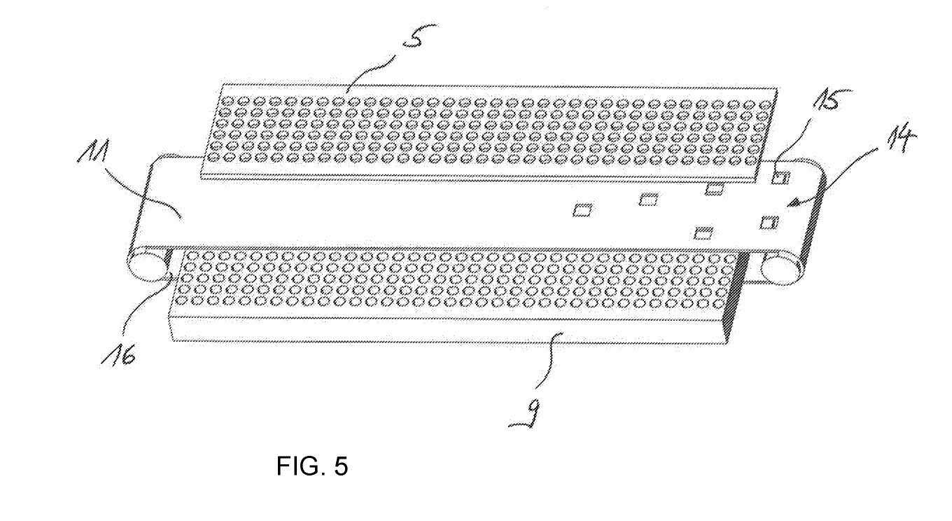

FIG. 5 shows an embodiment of the partition plate 11 in the form of a closed partition strip. The lower plate 9 is located within this partition strip while the upper plate 5 is located above this partition plate 11 which is constructed as a partition wall. In the illustration, the recess region with the recesses 15 is located precisely between the lower plate 9 and the upper plate 5, while the adjacent non-permeable plate or strip region 16 is located below the lower plate 9. In the removable variant and display panel which is provided for this, it comprises the upper plate 5 and the partition plate 11 which is constructed as a partition strip and the lower plate 9 which is practically surrounded by the partition plate 11 in the form of a partition wall.

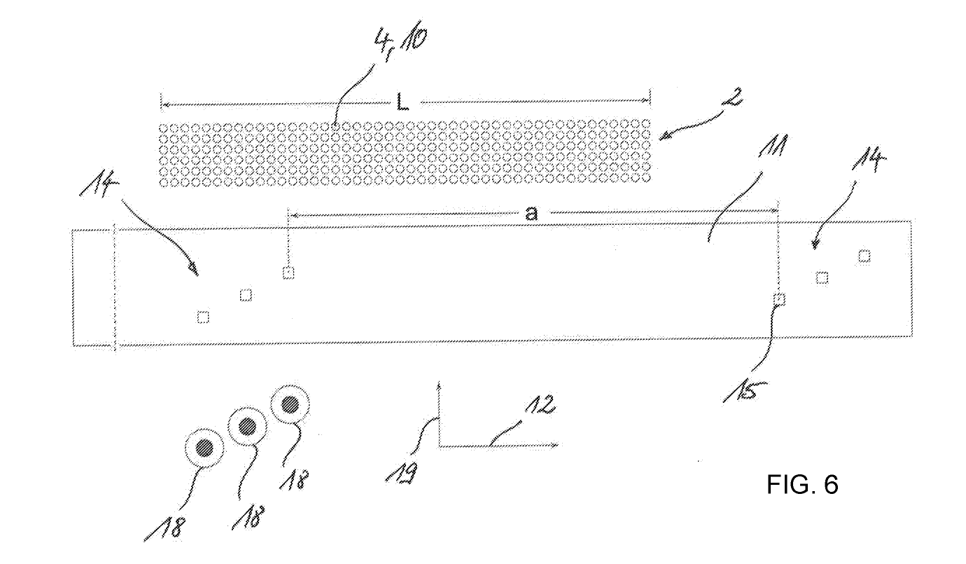

FIGS. 6 to 8 show variants of the arrangement and configuration of the recesses 15 along the partition plate 11. According to FIG. 6, by way of example, three recesses 15 are arranged in the movement direction 12 one behind the other and offset with respect to each other in the transverse direction 19 relative thereto. The corresponding arrangement of the writing heads 18 is also illustrated. In addition, a tactile hole grid which is again constructed as a matrix with lines and columns with touch openings 4 for receiving corresponding touch elements 3 is illustrated. The spacing a of the two recess regions which are shown corresponds to the length L of the touch hole grid and consequently the length of the display surface 2. In the embodiment according to FIG. 6, there is provided in each case only one writing head (solenoid) 18 for two recesses 15 and consequently for two adjacent lines of the opening grid of the catch openings 4, that is to say, in each case for the two upper, for the two central and for the two lower of the groups of three recesses 15 illustrated on the left and right.

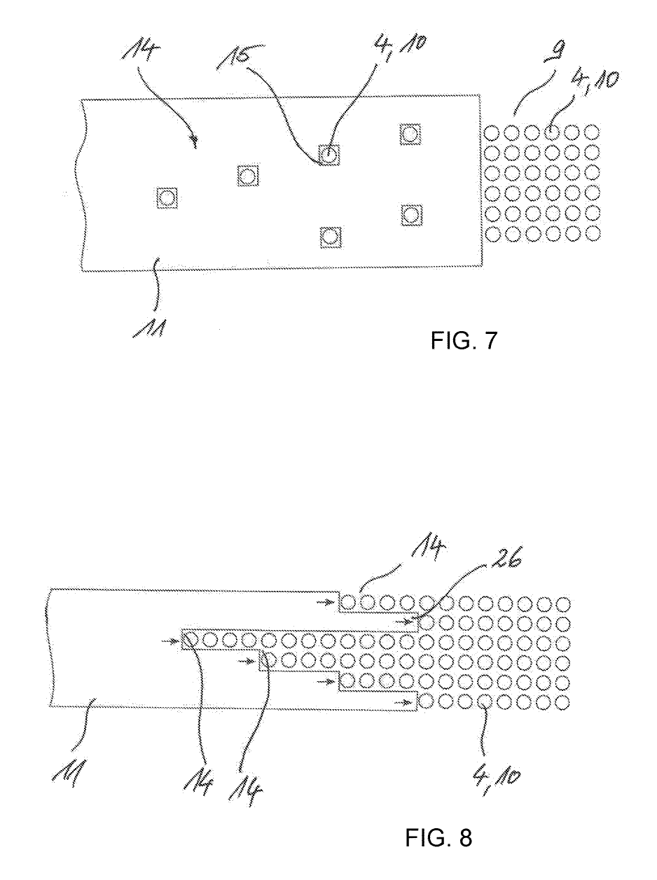

FIG. 7 shows a momentary state of the covering of the display surface 2 with the touch openings 4 of the upper plate 5 which are again arranged therein in a matrix-like manner and position openings 10 of the lower plate 9 corresponding thereto. The opening grid contains in this instance a total of six lines. Accordingly, the recess region of the partition plate 11 contains six recesses 15 which are partially arranged in lines beside each other and which are otherwise arranged offset one behind the other. It can be seen that each of the recesses 15 is aligned with a touch opening 4 or position opening 10 in one of the lines of the opening grid. While passing over the recess region of the partition plate 11 via the openings 4, 10, they are in alignment with each other and with the corresponding recess 15 in the respective line from column to column. In this manner, each touch opening 4 of the upper plate 5 can be charged with a touch element 3 or fall back from there into the lower plate 9 via the transport channel formed by the openings 4 and 10 and the corresponding recess 15.

FIG. 8 shows an embodiment of the recess region of the partition plate 11 in the form of a cutting edge pattern. The respective writing heads 18 are arranged therein at the positions indicated by the arrows 26. The offset thereof corresponds in the embodiment to the arrangement grid according to FIG. 7.

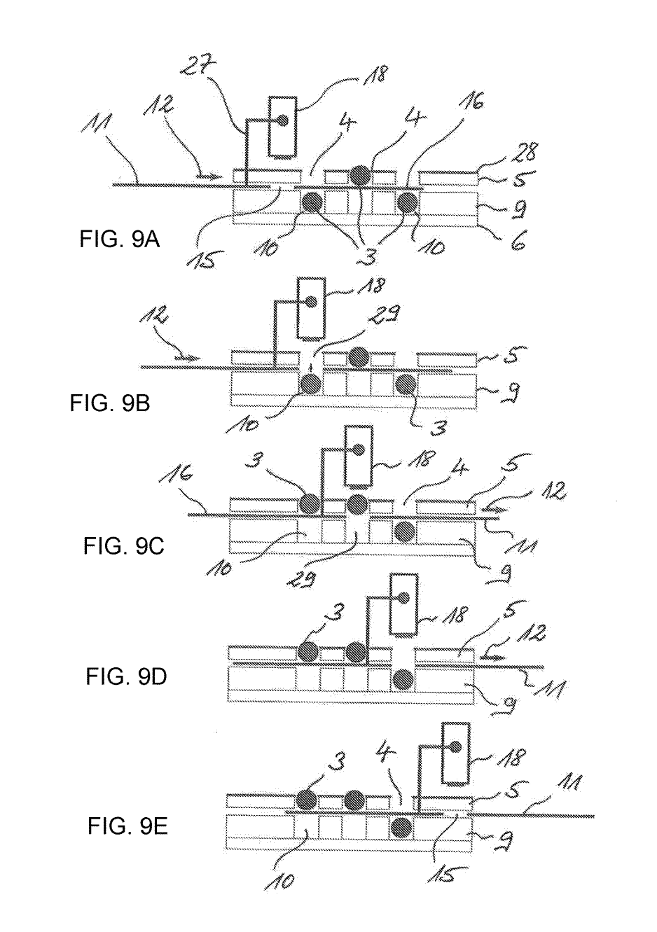

The operating method of the writing instrument 1 is illustrated in FIGS. 9A to 9E for a single touch dot row of the opening grid of the upper and lower plates 5 and 9, respectively. There is located between the upper plate 5 and the lower plate 9 the partition plate 11 which is moved in this instance in accordance with the indicated arrow in the movement direction 12 from left to right. There is located above this plate arrangement 5, 6, 9 one of the writing heads 18 of the writing head arrangement 17. The coupling of the corresponding writing head 18 to the partition plate 11 is illustrated by means of a connection line 27. A cover 28 on the upper plate 5 is additionally illustrated in a simplified manner. It can be seen that the partition plate 11 enables between the upper plate 5 and the lower plate 9 only at specific locations, at which a recess 15 in the partition plate 11 is located, a transport channel between a position opening 10 of the lower plate 9 and a corresponding touch opening 4 of the upper plate 5. The corresponding writing head 18 which corresponds to this line or row of the touch dot grid is always located above the recess 15.

In the illustration according to FIG. 9A, a touch element 3 is arranged in a corresponding touch opening 4 of the upper plate 5 and secured at that location by the non-permeable plate region 16 of the partition plate against falling back into the lower plate 9, while two additional touch elements 3 are arranged at that location in corresponding position openings 10. In this position of the partition plate 11, they cannot be transported through the non-permeable plate region 16 thereof into the corresponding touch openings 4 of the upper plate 5.

FIG. 9B shows the writing device 1 in a position which is guided further in the movement direction 12 and in which the corresponding writing head 18 is located above the left touch opening 4 in the drawings. In this position, the recess 15 of the partition plate 11 which is moved synchronously with the writing head 18 also overlaps this touch opening 4. This opening is itself in alignment with the corresponding position opening 10 of the lower plate 9 so that a corresponding transport channel 29 for the transport, that is to say a lifting of the touch element 3 from the lower plate 9 via the partition plate 11 into the upper plate 5, is enabled.

In the position of the writing head 18 with the partition plate 11, which position is advanced further in FIG. 9C in the movement direction 12, the non-permeable plate region 16 thereof is located below the previously charged touch opening 4 of the upper plate 5 with the touch element 3 which is located therein. The transport channel 29 which is adjacent thereto is now also released via the recess 15 of the partition plate 11 so that the touch element 3 which is located therein is either fixed in this position by the writing head 18 until the non-permeable plate region 16 of the partition plate also closes this transport channel 29 or this touch element 3 falls back into the lower plate 9 when the writing head 18 is deactivated in this position.

FIGS. 9D and 9E show the situation of the following transport channel 29 in the movement direction 12 by the touch opening 4 of the upper plate 5 and the recess 15 of the partition plate 11 and the position opening 10 of the lower plate 9 being in alignment with each other at this location. In this instance, it is illustrated by way of example that the writing head 18 is deactivated in such a manner that the corresponding touch element 3 remains in the lower plate 9 and the partition plate 11 with the non-permeable plate region 16 thereof closes the corresponding position opening 10 during the further movement of the partition plate 11 in the movement direction 12.

In order in particular to display a graphic, a large number of touch dots are required. In the embodiment of the writing instrument 1 illustrated in FIGS. 1 and 2, 384 touch dots can be illustrated in sixteen lines and fourteen columns. The opening grid of the upper and lower plates 5 and 9 is, as is usual with Braille script, approximately 2.5 mm. The diameter of the touch elements 3 which are constructed in this instance as balls is approximately 1.6 mm. The movable writing head arrangement 17 contains a total of sixteen solenoids as writing heads 18, that is to say, a solenoid for each line. Since, as a result of the comparatively large diameter of the solenoids, the matrix-like arrangement thereof would exceed the grid dimension of the touch dot grid, they are arranged offset with respect to each other.

As a result of such an offset arrangement of individual solenoids as writing heads 18 together with a partition plate 11 which has a recess region in the same arrangement grid of the solenoids between the upper plate 5 and the lower plate 9, this high number of touch dots can be produced on a practically minimal display surface 2 in a cost-saving manner. An additional cost saving can be achieved by only a fraction of the solenoids which corresponds to a fraction of the opening grid of the display surface 2 being used as writing heads 18. They travel or pass over, together with a correspondingly constructed partition plate 11, the corresponding line groups line by line one after the other, wherein the corresponding groups of touch openings 4 of the upper plate 5 are charged or touch elements 3 which have already been placed are guided back into the lower plate 9.

The invention is not limited to the embodiments described above. Instead, other variants of the invention can also be derived therefrom by the person skilled in the art without departing from the subject matter of the invention. In particular, it is further possible for all the individual features which are described together with the embodiments also to be combined with each other in a different manner without departing from the subject matter of the invention.

It is thus also possible to provide as a writing head arrangement, for example, a pneumatically operated transport or writing head arrangement which conveys via a corresponding arrangement of suction openings the touch elements 3 from the lower plate 9 into the upper plate 5. In addition, in place of the balls, differently shaped touch elements 3, for example, cylindrical pins or the like, may be provided. Furthermore, the position openings 10 of the lower plate 9 may be provided with through-openings which have a comparatively small diameter, that is to say, in particular extremely small diameter, and which enable the cleaning of the upper plate 5 and the lower plate 9 by a cleaning fluid without removing the touch elements 3. Furthermore, only a portion of the partition plate 11 which is constructed as a partition strip may be constructed to be resilient or flexible.

The following is a summary list of reference numerals and the corresponding structure used in the above description of the invention:
1 Writing instrument
2 Display surface
3 Tactile element/touch element
4 Touch opening
5 Upper plate
6 Guiding device
7 Display plane
8 Position plane
9 Lower plate
10 Position opening
11 Partition plate
12 Movement direction
13 Perforation
14 First plate region
15 Recess
16 Second plate region
17 Writing head arrangement
18 Writing head
19 Transverse direction
20 Return roller
21 Covering cap
22 Position sensor
23 Recess
24 Opening window
25 Retention strut
26 Position arrow
27 Connection line
28 Cover
29 Transport channel

1. A writing instrument for displaying a touch dot pattern which can be detected in a tactile manner, the writing instrument comprising:
a guiding device defining a position plane;
a lower plate disposed in the position plane of said guiding device, said lower plate having a number of position openings formed therein which are disposed in a matrix-like manner in an opening grid in columns and lines;
tactile elements disposed in said position openings so as to be able to be removed;
an upper plate disposed in a display plane being vertically spaced apart from the position plane, said upper plate having a number of touch openings formed therein and each of said touch openings being alignment with a corresponding one of said position openings of said lower plate;
a writing head configuration guided in a translational movement direction relative to said guiding device and having a plurality of writing heads corresponding to a number of the lines or a fraction thereof and convey said tactile elements from said lower plate into said upper plate in accordance with a dot pattern which is intended to be displayed;
a partition plate disposed between said lower plate and said upper plate and being guided in a translational manner in relative terms and having a first plate region being permeable to said tactile elements and having a number of recesses formed therein which correspond to the number of the lines of said opening grid of said position openings and/or a number of said writing heads or a fraction thereof and which has a second plate region adjoining said first plate region in the translational movement direction and which is non-permeable to said tactile elements; and
each of said recesses in said permeable first plate region is associated with each of said writing heads in such a manner that said recesses of said partition plate screen a transport channel between corresponding ones of said position openings and said touch openings of said lower and upper plates which are in alignment with each other.

2. The writing instrument according to claim 1, wherein in said writing head configuration at least some of said writing heads are disposed one behind another in the translational movement direction and offset in lines.

3. The writing instrument according to claim 1, wherein said writing head configuration is guided so as to also be able to be moved in an opposite direction to the translational movement direction.

4. The writing instrument according to claim 1, wherein said partition plate has at both sides of said first plate region which is permeable to said tactile elements said second plate region which is non-permeable to said tactile elements.

5. The writing instrument according to claim 1, wherein said first plate region which is permeable to said tactile elements has an opening window formed therein which extends in a transverse direction relative to the translational movement direction over at least one of the lines of the opening grid of said touch openings and/or said position openings and said recesses in the translational movement direction upstream and/or downstream of said opening window.

6. The writing instrument according to claim 1, wherein said second plate region which is non-permeable to said tactile elements has at least dimensions of the opening grid of the touch openings and/or said position openings and is releasably connected to said first plate region.

7. The writing instrument according to claim 6, wherein said second plate region of said partition plate, being non-permeable to said tactile elements, together with said upper plate is constructed so as to be able to be removable from said guiding device.

8. The writing instrument according to claim 1, wherein said partition plate is constructed as a resilient and/or closed partition strip.

9. The writing instrument according to claim 8, wherein said partition plate which is constructed as said resilient and/or closed partition strip, together with said upper plate is constructed so as to be able to be removable from said guiding device.

10. The writing instrument according to claim 1, wherein said recesses of said partition plate are disposed in a recess grid which corresponds to an arrangement grid of said writing heads.

11. The writing instrument according to claim 1, wherein said first plate region which is permeable to said tactile elements has an opening window formed therein which extends in a transverse direction relative to the translational movement direction over a plurality of the lines of the opening grid of said touch openings and/or said position openings and said recesses in the translational movement direction upstream and/or downstream of said opening window.

12. The writing instrument according to claim 1, wherein said first plate region which is permeable to said tactile elements has an opening window formed therein which extends in a transverse direction relative to the translational movement direction over all of the lines of the opening grid of said touch openings and/or said position openings and said recesses in the translational movement direction upstream and/or downstream of said opening window.

13. The writing instrument according to claim 6, wherein said second plate region of said partition plate being non-permeable to said tactile elements, together with said upper plate and said lower plate, is constructed so as to be able to be removable from said guiding device.

14. The writing instrument according to claim 8, wherein said partition plate which is constructed as the resilient and/or closed partition strip, together with said upper plate and said lower plate, is constructed so as to be able to be removable from said guiding device.
